(19) United States
(12) Patent Application Publication
(10) Pub. No.: US 2006/0244573 A1
(43) Pub. Date: Nov. 2, 2006

(54) Integration of antenna and solar charger for remote asset tracking

(76) Inventor: Steve Wendler, Flower Mound, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/369,176

(22) Filed: Mar. 6, 2006

Related U.S. Application Data
(60) Provisional application No. 60/659,238, filed on Mar. 7, 2005.

(51) Int. Cl. B60R 25/10

(52) U.S. Cl. 340/426.19; 340/333

(57) ABSTRACT

An apparatus comprises a solar array configured to provide power to an asset tracking device and antennas configured to provide signals to the asset tracking device. The solar array comprises a bank of solar cells that are connected to the asset tracking device. The solar cells are configured to provide power to enable operation of the asset tracking device when external power is not available to the asset tracking device. Power from the solar array may be used to directly power the asset tracking device and/or charge a battery used by the asset tracking device. The antennas may include a Global Navigation Satellite System (GNSS) antenna as well as antennas that are used by a wireless transceiver to receive and transmit information to and from the asset tracking device, respectively.

### RELATED APPLICATION

This application claims the benefit of U.S. Provisional Application No. 60/659,238, filed on Mar. 7, 2005. The entire teachings of the above application is incorporated herein by reference.

### BACKGROUND OF THE INVENTION

To be effective, remote asset tracking should support installation in applications where an asset can sit idle for weeks or months without an external power source. For example, a commonly tracked asset, such as dry van trailer, receives power when tethered to a tractor but may sit idle for weeks or months in an unpowered state when the trailer is no longer tethered. Typically, asset tracking devices used to track such dry van trailers may use rechargeable batteries that power the tracking device when the trailer is no longer tethered to a tractor. The rechargeable batteries are typically charged whenever the asset is powered externally (e.g., when powered by a tractor). The batteries typically act as a sole source of power to the tracking device for the periods where external power is not available. If external power is not available for several months, the battery may discharge, which may interrupt the tracking performance of the asset not only when it is idle, but also when the asset is first put into use (before the battery has had a chance to be recharged). Also, a battery may be damaged if it has been discharged for an extended period of time.

### SUMMARY OF THE INVENTION

The present invention overcomes these shortcomings by incorporating a power source that provides power to e.g., enable batteries in an asset tracking device to be charged when an external source of power normally used to charge the batteries is not available. Further, the present invention incorporates additional features, such as antennas, that may be used with the asset tracking device.

According to an embodiment of the invention, a power/antenna assembly, which is installed on the top rail of a trailer in place of a conventional clearance light assembly, contains a solar array and one or more antennas that are used by an asset tracking device associated with the trailer. The solar array comprises a bank of solar cells that are connected to the asset tracking device. The solar cells are configured to provide power to enable operation of the tracking device when external power is not available to the asset tracking device. Power from the solar cells may be used to charge a rechargeable battery that powers the asset tracking device. Alternatively, the solar cells may be used to directly power the asset tracking device. The antennas included in the power/antenna assembly are configured to accommodate a wireless transmitter and a Global Navigation Satellite System (GNSS) receiver associated with the asset tracking device.

Advantageously, the solar array acts to significantly extend the battery life of the tracking device as well as provide power to the tracking device when an external source of power is not available to the asset tracking device. Packaging these elements in a functional clearance light housing has the advantage of unobtrusive installation and operation.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of a vehicle that may be used with the present invention.

FIG. 2 is a high-level partial block diagram of an asset tracking device that may be used with the present invention.

FIGS. 3A-B are diagrams of a power/antenna assembly that may be used with the present invention.

FIG. 4 is a diagram illustrating a top-down view of a power/antenna assembly that may be used with the present invention.

FIG. 5 is a schematic view of an antenna module that may be used with the present invention.

FIG. 6 is a block diagram showing connections to various components that may be contained within a power/antenna assembly in accordance that may be used with the present invention.

### DETAILED DESCRIPTION OF THE INVENTION

A description of preferred embodiments of the invention follows.

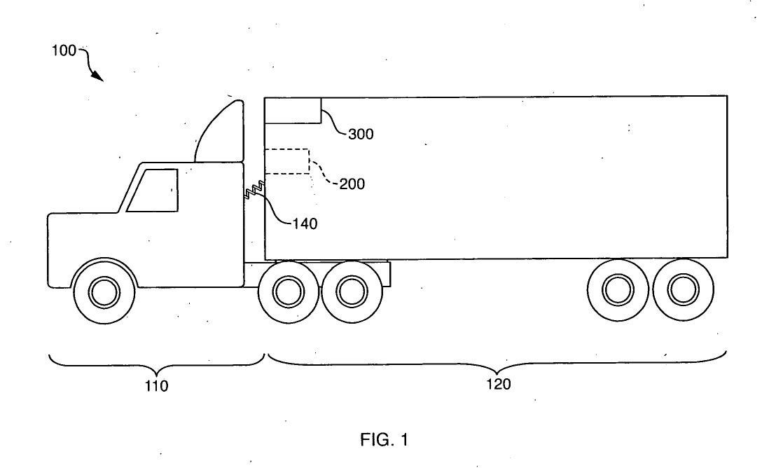

FIG. 1 is a diagram of a vehicle 100 that may be used with the present invention. Vehicle 100 is a conventional semi-tractor trailer comprising a tractor portion 110 and a trailer portion 120. The trailer contains an asset tracking device 200 and at least one power/antenna assembly 300 configured in accordance with the present invention. An external power source is provided to the asset tracking device 200 via power cable 140 when the trailer 120 is tethered to the tractor 110. In addition, as will be described further below, the power/antenna assembly 300 contains circuits capable of providing a power source and an antenna connection for the asset tracking device 200 when the tractor 110 is not providing an external power source to the asset tracking device 200 or otherwise tethered to trailer 120.

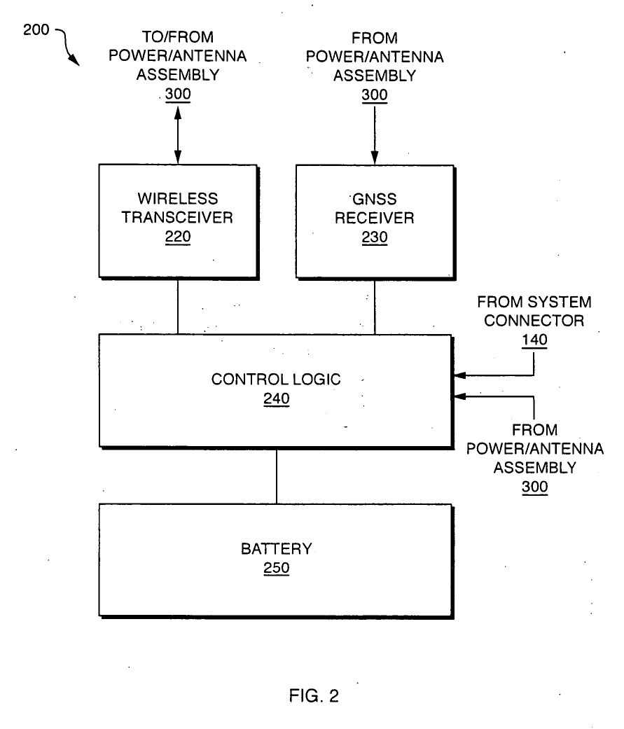

FIG. 2 is a high-level partial schematic block diagram of an asset tracking device 200 that may be used with the present invention. Device 200 comprises a wireless transceiver 220, a Global Navigation Satellite System (GNSS) receiver 230, control logic 240 and a battery 250. The wireless transceiver 220 is a conventional wireless transceiver that contains logic to enable data processed by the control logic to be transmitted to a remote asset tracking center (not shown) via e.g., a cellular telephone system. The GNSS receiver 230 is a conventional GNSS receiver that contains logic configured to receive signals from a GNSS system, such as the well-known Global Positioning System (GPS) currently provided by the United States Department of Defense, the Russian Global Navigation Satellite System (GLONASS), the European GALILEO system and the like. GNSS receiver 230 uses these signals to determine a location of the tracking device 200.

The control logic 240 contains logic that is illustratively configured to process location information supplied by the receiver 230. This processing may include generating asset tracking data or other status information that is transferred to the asset tracking center via the wireless transceiver 220. Moreover, the control logic 240 may contain battery charging circuitry that is used to charge the battery 250. Here, the battery charging circuitry may be configured to regulate a charging voltage and limit current (e.g., supplied from the power cable 140) that is delivered to the battery 250 as well as manage the overall battery charging process in order to properly charge the battery 250.

The battery 250 is a power source that is illustratively configured to provide power to the control logic 240, the wireless transceiver 220 and the receiver 230. Alternatively, the battery 250 may be configured to augment power to the control logic 240, wireless transceiver 220 and receiver 230 which may be powered directly from an external power source (e.g., supplied from the power cable 140) and/or the power/antenna assembly 300. In this configuration, excess power generated by the power/antenna assembly 300 and/or the external power source may used to charge the battery 250.

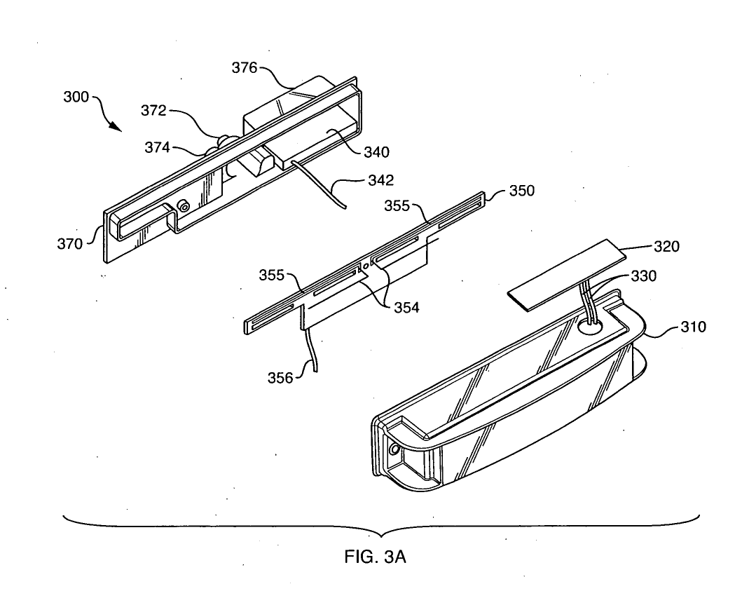

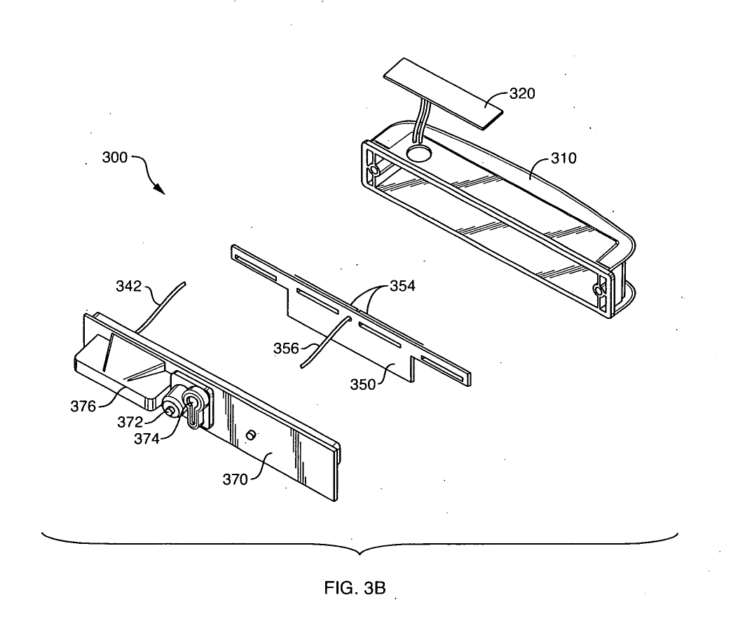

FIGS. 3A-B are diagrams illustrating various views of a power/antenna assembly 300 that may be used with the present invention. Power/antenna assembly 300 comprises a lens assembly 310, a solar array 320, a power connector 330, a GNSS antenna 340, an antenna module 350 and a housing 370.

The lens assembly 310 is a conventional clearance light lens which may be made of translucent plastic or alternatively opaque material. The solar array 320 is an array of conventional solar cells mounted to the lens assembly 310 and configured to convert light (e.g., solar energy) to electricity. The solar array 320 is illustratively mounted to the top of the lens assembly 310 although in alternative embodiments the solar array 320 is mounted in the inside of the lens assembly 310 provided the lens assembly is made of a translucent material that is sufficiently translucent to enable the array 320 to efficiently convert light to electricity. The power connector 330 couples the power/antenna unit with the battery 250. The GNSS antenna 340 is illustratively a conventional active antenna that is configured to receive signals from a GNSS system, such as, e.g., the above-described GPS, GLONASS and GALILEO systems. Antenna 340 is coupled to GNSS receiver 230 via cable 342.

The housing 370 is configured to enclose the back of the power/antenna unit 300 and serve as a support for various components. The housing 370 contains a mechanical platform 376 which may be used to hold the GNSS antenna 340, a cable access hole 372 which may be used as a feed-through to route cable 342 from the power/antenna unit 300 to the GNSS receiver 230 and an additional access hole 374 which may be used to route other cables, such as cable 356 from the antenna module 350 to the wireless transceiver 220.

The antenna module 350 comprises a 1.9 Gigahertz (GHz) antenna 354 and an 800 Megahertz (MHz) antenna 355. The antennal module 350 may optionally comprise a conventional light-emitting diode (LED) (not shown) that provides illumination to enable the power/antenna unit 300 to illustratively function as a clearance light. The 1.9 GHz antenna 354 and 800 MHz antenna 355 are coupled to the wireless transceiver 220 (FIG. 2) via cable 356 and configured to transmit and receive signals in the 1.9 GHz and 800 MHz bands, respectively.

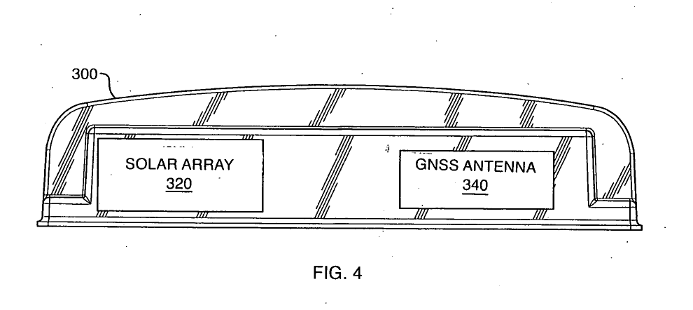

FIG. 4 is a diagram illustrating a top-down of power/antenna unit 300. The solar array 320 is illustratively affixed (attached) to the top of the lens assembly 310 using a suitable adhesive. The GNSS antenna 340 is illustratively located adjacent to the solar array 320, as shown.

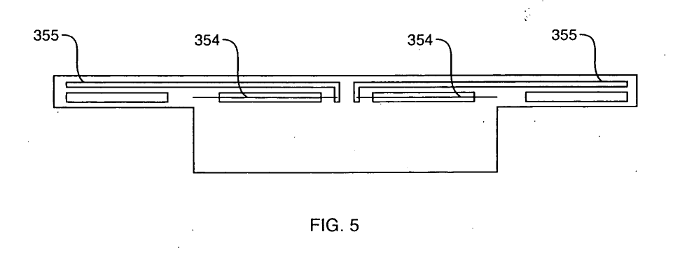

FIG. 5 is a plain view block diagram of the antenna module 350 showing a placement of the 1.9 GHz antenna 354 and 800 MHz antenna 355. The antennas 354, 355 are placed on a printed circuit board 358. The 800 MHz antenna 355 comprises two etches on the circuit board 358 which are arranged to form a dipole antenna. Likewise, the 1.9 GHz antenna 354 comprises two wires coupled to the etches and arranged to form a dipole antenna. Cable 356 is likewise coupled to the etches to provide a single feed point for both antennas.

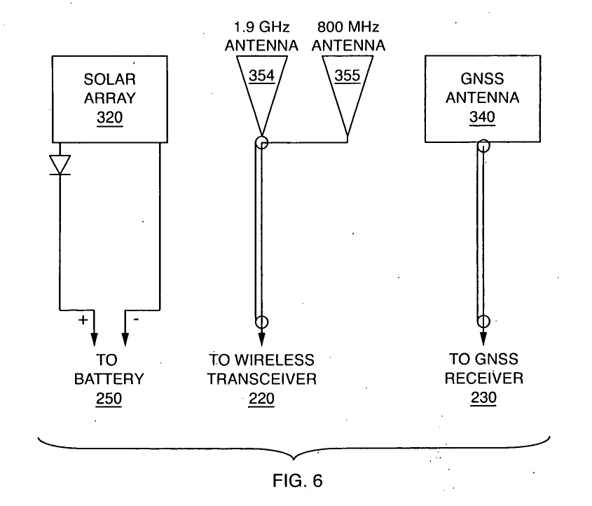

FIG. 6 is an electrical block diagram of various interconnections between components of the power/antenna unit 300 and units external to the power/antenna unit 300. The solar array 320 is illustratively coupled to the battery 250 to provide power to charge the battery 250. The 1.9 GHz antenna 354 and 800 MHz antenna 355 are illustratively coupled to the wireless transceiver 220 to enable the transceiver to transmit and receive signals in the 1.9 GHz and 800 MHz bands, respectively. The GNSS antenna 340 is illustratively coupled to the GNSS receiver 230 to enable the receiver 230 to receive signals from a GNSS satellite system.

Operationally, when the trailer 120 is tethered to the tractor 110, power is supplied from the tractor 110 via cable 140 to the battery 250. The battery supplies power to the control logic 240, the wireless transceiver 220 and the GNSS receiver 230. When the trailer 120 is not tethered to the tractor 110, electricity generated by the solar array 320 is illustratively transferred to the battery 250 to charge the battery. Alternatively, the electricity generated by the solar array 320 may be used to directly power the control logic 240, wireless transceiver 220 and GNSS receiver 230 which may be further augmented by power supplied by the battery 250.

Further, operationally, GNSS antenna 340 acquires signals from a GNSS system and provides the signals to the GNSS receiver 230. In addition, the 1.9 GHz antenna 354 and the 800 MHz antenna 355 enable wireless transceiver 220 to receive and transmit wireless signals in the 1.9 GHz and 800 MHz bands, respectively.

Illustratively, the power/antenna unit 300 is placed at the top of trailer 120 in a conventional clearance light location. Positioning the power/antenna unit in this manner enables light to be easily collected by the solar array 320 as well as provide a good locale for antenna 340 for receiving GNSS signals for the GNSS receiver 230 and antennas 354, 355 for transmitting/receiving wireless signals for the wireless transceiver 220.

As noted above, the power/antenna unit 300 may be used to provide power to recharge the battery 250. This acts to improve the battery's performance, especially for assets (e.g., trailers 120) that sit idle without external power for extended periods. This enables the asset's current status to be available during periods when the asset is not connected to an external power source (e.g., an idle period). Moreover, since the battery is kept charged by the power/antenna unit 300, the status of the asset is immediately available when it is put into use. This offers significantly more value to, e.g., a customer, to have asset tracking available continuously.

Incorporating the solar cells into the same housing that incorporates the antenna provides many advantages. The solar cells, GNSS and communication system antennas are integrated into an assembly that has the same size and shape as an existing assembly and thus does not necessarily require additional installation hardware. The use of a clearance light assembly offers a high mounting location suitable for solar collection. The invention provides an advantage over solar collection arrays using mounting devices on the surface of the roof, which may not be generally allowed or desirable in many instances.

While this invention has been particularly shown and described with references to preferred embodiments thereof, it will be understood by those skilled in the art that various changes in form and details may be made therein without departing from the scope of the invention encompassed by the appended claims.

1. An apparatus for powering an asset tracking device, the apparatus comprising:
a clearance light lens assembly; and
a solar array affixed to the lens assembly and coupled to the asset tracking device to provide power to the asset tracking device.

2. An apparatus as defined in claim 1 further comprising:
an antenna.

3. An apparatus as defined in claim 2 wherein the antenna is coupled to the asset tracking device.

4. An apparatus as defined in claim 2 wherein the antenna is coupled to a Global Navigation Satellite System (GNSS) receiver capable of receiving GNSS signals.

5. An apparatus as defined in claim 2 further comprising:
a second antenna coupled to a wireless transceiver.

6. An apparatus as defined in claim 1 further comprising:
a battery.

7. An apparatus as defined in claim 6 wherein the solar array is configured to supply power to charge the battery.

8. An apparatus as defined in claim 2 further comprising:
a light-emitting diode (LED).
